(19) United States
(12) Patent Application Publication
(10) Pub. No.: US 2017/0031910 A1
(43) Pub. Date: Feb. 2, 2017

(54) UPDATING SERVICE LEVEL TARGETS

(71) Applicant: Hewlett-Packard Development Company, L.P., Houston, TX (US)

(72) Inventors: Einat Atedgi, Yehud (IL); Ran Biron, Yehud (IL); Gil Tzadikevitch, Yehud (IL); Jony Vesterman Cohen, Yehud (IL); Yoni Roit, Yehud (IL)

(21) Appl. No.: 14/815,179

(22) Filed: Jul. 31, 2015

(51) Int. Cl. G06F 17/30; G06Q 10/06

(52) U.S. Cl. CPC G06F 17/3038; G06F 17/30339; G06Q 10/06393

(57) ABSTRACT

Updating service level targets may include aggregating a plurality of actions performed over each of a plurality of information technology service management (ITSM) records in a single service level target (SLT) database table since a prior update. Examples may include applying the aggregated plurality of actions to the SLT database table in a bulk operation. Examples may further include updating, at a predetermined elapsed time, each of the plurality of ITSM records in the SLT database table.

### BACKGROUND

A Service Level Target (SLT) may be a measurable commitment to provide a service. In Information Technology Service Management (ITSM) and ITSM applications (e.g., software applications—directed by policies, organized and structured in processes and supporting procedures—that are performed to deliver, operate, and control IT services offered to customers, etc.), a SLT may be utilized as a metric target achieving or exceeding a commitment that may be defined in a Service Level Agreement (SLA), e.g. an agreement between an IT service provider and a customer, describing the IT service, documenting the SLTs, specifying the responsibilities of the IT service provider and the Customer, defining business goals as they relate to IT services, etc. The SLTs may be target metrics comparable to SLT metrics of IT service provision (e.g., Key Performance Indicators (KPIs)) in order to determine if an ITSM application design is fit for purpose e.g. capable of meeting its objectives and service levels.

### BRIEF DESCRIPTION OF THE DRAWINGS

FIG. 1 illustrates a diagram of an example of a system of service level target tracking according to the present disclosure.

FIG. 2 illustrates a diagram of an example of a computing device according to the present disclosure.

FIG. 3 illustrates an example of an environment for service level target tracking according to the present disclosure.

FIG. 4 illustrates a flow chart of an example of a method of service level target tracking according to the present disclosure.

### DETAILED DESCRIPTION

An ITSM record may include an IT service item. Examples of IT service items may include a request from a customer for an IT service, an IT incident, and/or various other occurrences associated with a demand for IT services and/or IT service resources. The ITSM record may be referred to as an IT ticket or may be referred to as associated with an IT ticket in the ITSM system. The ITSM record may include a record of an IT event and/or occurrence. The ITSM record may include various attributes of the underlying event and/or occurrence. The ITSM record may include details regarding the ITSM status of the ITSM record. The ITSM record may include details of the assignment and the application of IT service resources to the event and/or occurrence. That is, the ITSM record may include various data associated with identification of, submission of, addressing of, notes regarding, status of, timing of, correspondence associated with, and/or resource requirement tracking of an IT service item and the provision of IT service resources to address and/or solve that item.

In ITSM applications SLT metrics may be utilized to track and/or measure aspects of a response of the IT staff to a variety of ITSM records. The ITSM records may be opened based on actions of an end user. In some examples the ITSM records tracked and/or measured by SLT metrics are IT incidents (e.g., a failure and/or problem with a resource under management of the ITSM application and/or IT staff) and requests (e.g., a particular requests for provision of an IT service related to modification and/or problem resolution of a IT resource under management of the ITSM application and/or IT staff).

An ITSM record may have a lifecycle associated therewith. That is, an ITSM record may have a series of events and/or occurrences which may happen to the ITSM record or be progressed through by the ITSM record. The lifecycle may include a number of milestone events and/or occurrences. These milestones may be predetermined events and/or occurrences achieved by the ITSM record and/or the underlying IT service item. The milestones may be utilized within a SLT tracking mechanism. That is, a milestone may be a target event and/or occurrence, progress toward which can be quantified with an SLT metric. The milestone (e.g., target) may be defined by properties. That is properties may be combined to constitute a milestone-definition for an ITSM record. The milestone-definition can include a definition of milestone events and/or occurrences that should be achieved in order for the ITSM record to achieve the milestone. Additionally, a target-definition can be assigned to an ITSM record. A target definition can include properties that define various aspects of how the ITSM record will be assigned to IT resources and how much time is allowed to pass before a specific resolution must be applied to the ITSM record. In this manner, the target-definition can define the events and/or occurrences that should be achieved in order to achieve the milestone. The properties may be properties of the ITSM record including SLT metrics associated with the ITSM record. The target-definition may define an SLT metric value and/or how the SLT metric is calculated for a particular milestone event and/or occurrence.

A SLT tracking mechanism may include determining SLT information such as an SLT status. Determining a SLT status may include comparing an SLT metric against a SLT to determine an SLT status. An SLT status may be a determination and/or an indication that an SLT metric has reached a predetermined level such as a milestone defined by a target definition for the particular ITSM record. Tracked and/or determined the SLT status and/or SLT metrics may be provided in the granularity of a single target defined over a single ITSM record.

The SLT information may be calculated based on actions performed over the ITSM record. For example, opening an ITSM record may start a count and/or a timer which represents an SLT metric that may be utilized in determining an SLT status. For example, opening the ITSM record may begin a timer which measures the time elapsed since the opening of the record and the timer may be utilized to determine whether the ITSM record was closed and/or the underlying ITSM item was resolved within a time specified by the SLT. There are additional actions that may be performed over an ITSM record that may affect an SLT calculation. For example, an IT agent and/or an end-user may perform an action that will suspend the target (e.g., the target will not be counted until another action un-suspends it). An additional example may include an action that will reassign the ITSM record to another target-definition. An action may also include resolving an ITSM record leading to closing of the ITSM record.

SLT tracking mechanisms may be based on an event-based calculation. That is, following each action performed over an SLT-supported ITSM record, a calculation may be performed to determine the SLT status associated with the ITSM record. The calculation includes querying and updating specific database tables that hold SLT-related history, current SLT status (e.g., achieved, failed, breached, etc.), and/or SLT state (e.g., active, inactive, etc.) of each ITSM record. That is, following each action that is taken over an ITSM record, a calculation may be performed, the relevant target state and/or status may be updated, and the determined information may be saved in a dedicated audit record. The audit record may be later used to calculate and/or modify an SLT metric such as elapsed duration and/or make a determination of whether a target elapsed-duration has been reached or breached.

The event-based calculation of SLT tracking mechanisms may be used to determine the correct SLT state. However, the event-based calculation poses a computational overhead on the ITSM system which may grow with the number of ITSM records and/or actions taken over the ITSM records. That is, each calculation may impose a small computation cost on the ITSM system, but considering that such calculations may be performed over a large amount of ITSM records simultaneously, the computational overhead rapidly poses a strain on the ITSM system. The strain on the ITSM system may limit the performance of the ITSM system by limiting the number of SLT-supported records in an ITSM system, which may, in turn, limit the number of customers that an ITSM system may commit to.

In contrast to the SLT tracking mechanism of ITSM systems described above that involve additional computation and memory resources in order to support additional SLT-supported records, examples included herein may decrease computational overhead of SLT calculations by utilizing a bulk-based SLT tracking system over a database. For example, a bulk-based SLT tracking mechanism may include aggregating a plurality of actions performed over each of a plurality of ITSM records in a single SLT database table since a prior update, applying the aggregated plurality of actions to the SLT database in a bulk operation, and updating, at a predetermined frequency, each of the plurality of ITSM records in the SLT database.

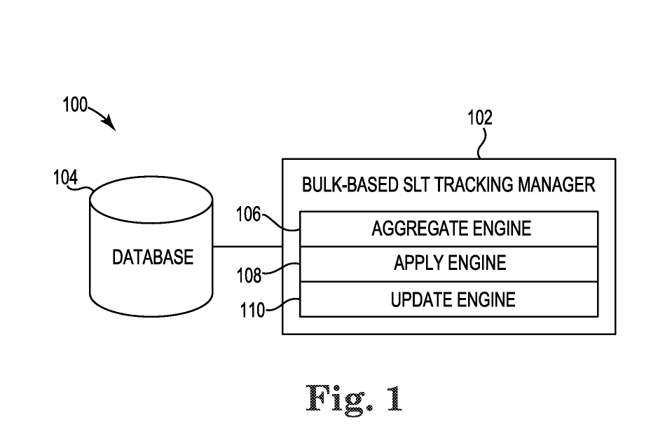

FIG. 1 illustrates a diagram of an example system 100 for bulk-based SLT tracking. The system 100 may include a database 104, a bulk-based SLT tracking manager 102, and/or a number of engines (e.g., an aggregate engine 106, apply engine 108, update engine 110, etc.). The bulk-based SLT tracking manager 102 may include additional or fewer engines than are illustrated to perform the various operations as will be described in further detail.

The number of engines (e.g., an aggregate engine 106, apply engine 108, update engine 110, etc.) may include a combination of hardware and programming (e.g., instructions executable by the hardware), but at least hardware, that is configured to perform operations described herein (e.g., aggregating a plurality of actions performed over each of a plurality of ITSM records in a single SLT database table since a prior update, applying the aggregated plurality of actions to the SLT database in a bulk operation, updating, at a predetermined frequency, each of the plurality of ITSM records in the SLT database etc.). The programming may include program instructions (e.g., software, firmware, etc.) stored in a memory resource (e.g., computer readable medium, machine readable medium, etc.) as well as hard-wired program (e.g., logic).

The aggregate engine 106 may include hardware and/or a combination of hardware and programming, but at least hardware to aggregate a plurality of actions performed over each of a plurality of ITSM records in a single SLT database table having occurred since a prior update. As used herein, an action performed over an ITSM record may include an action performed by an ITSM resource, such as an IT agent assigned to a particular ITSM record and/or an ITSM computational resource, in the course of satisfying an IT service request associated with the particular ITSM record.

An action may include activity of an ITSM resource associated with opening an ITSM record. For example, an action may include an activity that initiates creation of the ITSM record in the system and/or assigns the created record to an ITSM resource.

An action may include activity of an ITSM resource associated with starting the application of IT resources to the ITSM record. For example, an action may include an activity that initiates completion of the assignment of the ITSM record to an ITSM resource.

In some examples, an action may include activity of an ITSM resource associated with stopping an ITSM record. For example, an action may include an activity that resolves (e.g., resolving an IT issue, completing an IT request, completing a series of activities associated with the ITSM record) or closes an ITSM record and/or generates a record of the resolution or closing.

The action may also include activity of an ITSM resource associated with suspending progress and/or work toward resolution of the ITSM record. For example, the suspending action may include an IT service agent submitting a request for further information from an end user associated with an ITSM record. In an example, the suspending action may include an action by an end user associated with the ITSM record. The suspending action may halt the progression of a measurement of time spent and/or previously available to have been spent working on the ITSM record.

The action may include activity of an ITSM resource associated with unsuspending/resuming progress and/or work toward resolution of the ITSM record. For example, the unsuspending action may include an activity such as receiving a response to a request for further information from an end user associated with an ITSM record. The unsuspending action may resume the progression of a measurement of time spent and/or previously available to have been spent working on the ITSM record.

The action may include activity of an ITSM resource associated with restarting progress and/or work toward resolution of the ITSM record. For example, the unsuspending action may include an activity such as restarting an ITSM record, following a resolution and/or prior closing of the ITSM record, upon reemergence of an IT issue underlying the ITSM record. The restart action may restart the progression of a measurement on the time spent and/or previously available to have been spent working on the ITSM record.

The aggregate engine 106 may include hardware and/or a combination of hardware and programming, but at least hardware to identify which of the above described actions are performed over each corresponding ITSM record. Additionally, the aggregate engine 106 may include hardware and/or a combination of hardware and programming, but at least hardware to identify a type associated with each action. Further, the aggregate engine 106 may include hardware and/or a combination of hardware and programming, but at least hardware to determine those actions of the plurality of actions that are the same type. In some examples, the actions may be identical. However, to be a same type, two actions need not be identical, but rather may be actions that are commonly grouped. Examples of action types may include a “create” action type associated with an action that opens an ITSM record, and/or opens an IT ticket associated with an IT service item; a “start” action type associated with an action that starts the application of IT resources (e.g., work) on the ITSM record and/or initiates a measurement of an elapsed duration of work on the ITSM record; a “stop” action type associated with an action that stops work on the ITSM record, closes an ITSM record, and/or stops the measurement of the elapsed duration of the work on the ITSM record; a “suspend” action type associated with an action that suspends work on the ITSM record and/or suspends measurement of the elapsed duration of work on the ITSM record; an “unsuspend” action type associated with an action resumes work on the ITSM record and/or resumes measurement of the elapsed duration of work on the ITSM record; and a “restart” action type associated with an action that initializes/reinitializes work on the ITSM record and/or initializes/reinitializes measurement of the elapsed duration of work on the ITSM record restarting the measurement to a beginning point such as time zero.

An example of an action associated with a “create” action type may include the submission of a request for IT assistance. The request for IT assistance may be generated by a submission of an end user that causes an ITSM record to be generated in association with that request. An example of an action associated with a “start” action type may include the assignment of an IT resource, such as an IT service agent, to the above mentioned example request for IT assistance. An example of an action associated with a “suspend” action type may include the assigned IT service agent noting that further information is necessary to process the above mentioned example request and/or sending correspondence to the end user requesting that information. An example of an action associated with an “unsuspend” action type may include receiving a reply from an end user to a request for further information. An example of an action associated with a “stop” action type may include receiving an indication from an IT service agent and/or the end user that the above mentioned request for IT assistance has been satisfied and the underlying IT event has been resolved. An example of an action associated with a “restart” action type may include an indication that the IT event underlying the above mentioned request for IT assistance has reemerged and/or the resolution was incomplete causing the ITSM record to be reopened.

The aggregate engine 106 may include hardware and/or a combination of hardware and programming, but at least hardware to translate user actions to the above described action types. For example, the actions may be analyzed and their characteristics and/or resulting outcomes may be determined and matched to an action type.

The aggregate engine 106 may include hardware and/or a combination of hardware and programming, but at least hardware to aggregate actions of a specific type into a single operation or an instruction for a single operation. For example, all actions performed over a plurality of ITSM records since a previous update of the single SLT database in which the corresponding SLT database entries are housed and/or since a predetermined elapsed amount of time since the last update (e.g., one minute, etc.) may be aggregated into action types to be applied as an update to the corresponding SLT database entries in a bulk operation. The bulk operation may include a single structured query language (SQL) operation over the SLT database entries.

In some examples, a compression mechanism may be utilized to handle different actions over the same target occurring in the same predetermined elapsed period of time (e.g., a start type action, a suspend type action, an unsuspend type action all occurring to the same ITSM record over the same one minute that has elapsed since the prior update).

The SLT database utilized in the system 100 for bulk-based SLT tracking may include a single database table that may store the SLT state of a plurality of SLT database entries defined over corresponding ITSM records. The SLT state of a database entry and/or a corresponding ITSM record may include a designation of whether the ITSM record is active or inactive. An active ITSM record may be one that is currently being worked on. An active ITSM record may be one that has had work on it started, has had work unsuspended on it, and/or has had work restarted on it and is not currently stopped or suspended. An active ITSM record may be one where an elapsed-duration measurement of time spent working on resolving the ITSM record actively progressing.

Conversely, an inactive ITSM record may be one that is not currently being worked on and/or is stopped, suspended, or closed. An inactive ITSM record may be one that has had work on it suspended and/or stopped and is not currently started, restarted, or unsuspended. An inactive ITSM record may be one where an elapsed-duration measurement of time spent working on resolving the ITSM record is halted and/or not being actively progressed.

Performance of the operations described herein (e.g., aggregating a plurality of actions performed over each of a plurality of ITSM records in a single SLT database table since a prior update, applying the aggregated plurality of actions to the SLT database in a bulk operation, updating, at a predetermined elapsed time, each of the plurality of ITSM records in the SLT database etc.) may include performing the operations and associated calculations directly over the single database table in a bulk operation (e.g., all actions from each action type in a single SQL operation).

The SLT database may additionally include a comprehensive set of values for each single SLT database entry. For example, the SLT database entry may include a comprehensive representation of the SLT information associated with an ITSM record corresponding to the SLT database entry. The SLT database may include any measurements and/or other metrics associated with the SLT information for each SLT database entry. For example, the SLT database may include a target date, an elapsed duration, and/or an SLT status for each SLT database entry.

As used herein, a target date may include the time (estimated date, hour, minute, second, etc. of completion) by which a target (e.g., resolution of an ITSM record) should be achieved according to a commitment (e.g., SLA, etc.). The date may be calculated according to a target-duration (e.g., a total amount of time allotted to resolution of an ITSM record corresponding to an SLT database entry according to an SLA, etc.) in combination with a working-schedule of assigned ITSM resources (e.g., computational resources, IT service agents, etc.).

As used herein, an elapsed-duration may include how much time has already been spent working on the ITSM record corresponding to the SLT database entry. The elapsed-duration may include a measurement of the amount of time that has actually been spent working on the ITSM record as opposed to simply the time elapsed since it was opened. The elapsed-duration measurement may be limited to those instances where the ITSM record was active and not suspended or stopped. The elapsed-duration for a given SLT database entry may be calculated according to the working-schedule, and/or the SLT status associated with that SLT database entry.

As used herein, an SLT status may include a status that is associated with an ITSM record and/or a corresponding SLT database entry. The status may include a designation of whether the ITSM record is active. An ITSM record may be active when it has been created and/or assigned to an IT service agent and is currently open and being worked on. The ITSM record may be considered active prior to the ITSM record being closed and/or an action being taken over the ITSM record which is a “stop” action type that resolves the underlying IT service item and closing the ITSM record.

The status may include a designation of whether the ITSM record is breached. An ITSM record may be breached when the ITSM record is currently open and being worked on, but the elapsed duration has already exceeded the target-duration and/or amount of time specified in a commitment such as an SLA limiting the maximum amount of time that may be spent on the ITSM record before the resolution should occur.

The status may include a designation of whether the ITSM record is achieved. An ITSM record may be achieved when the ITSM record is resolved and/or closed while its elapsed duration is smaller than or equal to the target-duration and/or the amount of time specified in a commitment such as an SLA limiting the maximum amount of time that may be spent on the ITSM record before the resolution should occur.

The status may include a designation of whether the ITSM record is failed. An ITSM record may be designated as failed when a milestone (e.g., initial review, assignment to an IT service agent, resolution of the ITSM record, etc.) wasn't reached within a defined target-duration according to a defined working schedule. An ITSM record may be designated as failed when the milestone wasn't reached within a defined target-duration and the ITSM record is closed and/or work is no longer being performed on it.

The apply engine 108 may include hardware and/or a combination of hardware and programming, but at least hardware, to apply the aggregated plurality of actions to the SLT database table in a bulk operation. Applying the aggregated actions may include performing an action such as a calculation over an SLT database entry and/or performing an alteration of the SLT database entry to reflect the consequence of the actions being applied. Applying the aggregated plurality of actions may include performing each of a plurality of aggregated actions of a specific type in a single operation. For example, applying the aggregated plurality of actions may include altering the SLT state of a number of different SLT database entries corresponding to ITSM records based on a corresponding applied action. In an example, an ITSM record having an unsuspend action type performed over it since the prior update may result in a change to a corresponding SLT state associated with an SLT database entry to reflect a change to an active SLT state. Modifying an SLT state of multiple SLT database entries corresponding to multiple distinct ITSM records may be performed in a bulk operation such as in a single SQL operation performed directly over the SLT database entries.

The update engine 110 may include hardware and/or a combination of hardware and programming, but at least hardware, to update, at a predetermined elapsed time, each of the plurality of ITSM records in the SLT database table. In contrast to prior action based methods of updating ITSM records, examples herein include updating the SLT database table entries corresponding to ITSM records at a predetermined elapsed time. That is, the update may occur at a predetermined frequency and may be based on time that has elapsed since the last update. In one example, the SLT database table entries may be updated every minute.

Updating each of the plurality of ITSM records may include modifying the SLT database entry included in the SLT database table that corresponds to each of the plurality of ITSM records. Specifically, updating each of the plurality of ITSM records may include updating SLT information associated with each SLT database entry.

For example, updating each of the plurality of ITSM records may include updating an elapsed-duration of each of the plurality of ITSM records in a single operation. An amount of time may elapse while the ITSM record is active. An elapsed-duration may be a measurement of the amount of time that has elapsed while the ITSM record has been active and/or worked on. Additionally, an elapsed-duration may be an amount of time that has elapsed since the ITSM record has been created, is active, and could be worked on. A determination of whether an ITSM record could be worked on may be made based on a working schedule of the availability an ITSM resource to which it is assigned. In this manner, the elapsed-duration may exclude from its measurement, elapsed time during which an assigned IT resource is unavailable, elapsed time during which the ITSM record has not yet been created, and/or elapsed time during which the ITSM record has an inactive SLT state (e.g., periods during which a “stop” or “suspend” action type is performed over the ITSM record).

Updating the elapsed-duration of each of the plurality of ITSM records in the single operation may include progressing a measurement of elapsed time for each of the plurality of ITSM records by an amount of time since the prior update during which the record had an active SLT status. Further, the elapsed-duration progression may be limited to the portion of the time elapsed since a previous update of the SLT database during which the SLT status of the SLT database entry corresponding to the ITSM record is active and when an IT resource to which the ITSM record is assigned is available to work on the ITSM record (e.g., according to a working schedule).

In another example, updating each of the plurality of ITSM records may include determining an updated SLT status of each of the plurality of ITSM records. Determining an updated SLT state may be based on comparing a corresponding updated elapsed-duration and a target-duration for each of the plurality of ITSM records. For example, an SLT state may be determined by examining whether the elapsed-duration measured for an ITSM record is within the target-duration for the ITSM record. In an example, if an elapsed-duration measurement of the ITSM record activity is within a target duration and the ITSM SLT state is active, then the SLT status may be updated to active. In another example, if an elapsed-duration measurement of the ITSM record activity is within a target duration and the ITSM SLT state is inactive (e.g., as a result of a stop action type being performed over the ITSM record), then the SLT status may be updated to achieved. In an example, if an elapsed-duration measurement of the ITSM record activity is outside of a target-duration and the ITSM SLT state is inactive (e.g., as a result of a stop action type being performed over the ITSM record), then the SLT status may be updated to failed. In an example, if an elapsed-duration measurement of the ITSM record activity is outside of a target-duration and the ITSM SLT state is active, then the SLT status may be updated to breached.

Updating, in a single operation, each of the plurality of ITSM records may further include modifying the target-date associated with an SLT database entry included in the SLT database table that corresponds to each of the plurality of ITSM records. The target-date may include a targeted point of time for completion of resolution of the ITSM record. The target-date may be based on the elapsed-duration of activity on the ITSM record, the working schedule of ITSM resources to which the ITSM record is assigned, and/or the target-duration terms specified in an SLA. Updating the target-date may include modifying the target-date based on changes to the elapsed duration, the working schedule, and a target duration specified in an SLA occurring since a prior update of the SLT database table.

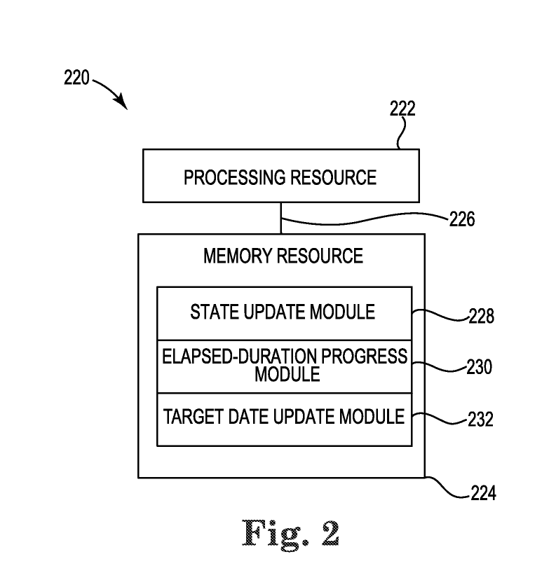

FIG. 2 illustrates a diagram of an example of a computing device 220 according to the present disclosure. The computing device 220 may utilize software, hardware, firmware, and/or logic to perform operations described herein.

The computing device 220 may be any combination of hardware and program instructions to share information. The hardware, for example, may include a processing resource 222 and/or a memory resource 224 (e.g., non-transitory computer-readable medium (CRM), machine readable medium (MRM), database, etc.). A processing resource 222, as used herein, may include any number of processors capable of executing instructions stored by a memory resource 224. Processing resource 222 may be implemented in a single device or distributed across multiple devices. The program instructions (e.g., computer readable instructions (CRI)) may include instructions stored on the memory resource 224 and executable by the processing resource 222 to implement a desired operation (e.g., update each of a plurality of ITSM records in a SLT database in a single bulk operation at a predetermined elapsed time, updating the SLT state of each of the plurality of ITSM records based on an aggregation of a plurality of actions performed on each of the ITSM records since a prior update of the SLT database, progressing an elapsed-duration of each of the plurality of ITSM records based on a corresponding updated SLT state of each of the plurality of ITSM records, updating a target date of each of the plurality of ITSM records based on the corresponding updated elapsed-duration of each of the plurality of the ITSM records, etc.)

The memory resource 224 may be in communication with the processing resource 222 via a communication link (e.g., a path) 226. The communication link 226 may be local or remote to a machine (e.g., a computing device) associated with the processing resource 222. Examples of a local communication link 226 may include an electronic bus internal to a machine (e.g., a computing device) where the memory resource 224 is one of volatile, non-volatile, fixed, and/or removable storage medium in communication with the processing resource 222 via the electronic bus.

A number of modules (e.g., state update module 228, elapsed-duration progress module 230, target date update module 232, etc.) may include CRI that when executed by the processing resource 222 may perform operations. The number of modules (e.g., state update module 228, elapsed-duration progress module 230, target date update module 232, etc.) may be sub-modules of other modules. For example, the state update module 228 and elapsed-duration progress module 230 may be sub-modules and/or contained within the same computing device. In another example, the number of modules (e.g., state update module 228, elapsed-duration progress module 230, target date update module 232, etc.) may comprise individual modules at separate and distinct locations (e.g., CRM, etc.).

Each of the number of modules (e.g., state update module 228, elapsed-duration progress module 230, target date update module 232, etc.) may include instructions that when executed by the processing resource 222 may operate as a corresponding engine as described herein. For example, the state update module 228, elapsed-duration module 230, and target date update module 232 may include instructions that when executed by the processing resource 222 may operate as the update engine 110.

The state update module 228 may include CRI that when executed by the processing resource 222 may update each of a plurality of ITSM records in a single SLT database in a single bulk operation at a predetermined elapsed time. Updating an ITSM record may include updating and/or modifying SLT information associated with a SLT database entry corresponding to the ITSM record. For example, updating the plurality of ITSM records may include updating the SLT state associated with each of the SLT database entries corresponding to the plurality of ITSM records. The SLT state of an ITSM record may be updated based on an aggregation of a plurality of actions performed on each of the ITSM records since a prior update of the SLT database. For example, a plurality of actions that are aggregated for application to the SLT database entries in a single operation may include actions that modify the SLT state from active to inactive or inactive to active. These SLT state modifying actions may occur within a period of time (e.g., the predetermined elapsed time) between updates of the SLT database. In such examples, the SLT state of an ITSM record may be modified to reflect the new SLT state. Modifying the SLT state may include updating an SLT state stored in an SLT database entry corresponding to the ITSM record.

The elapsed-duration progress module 230 may include CRI that when executed by the processing resource 222 may include progressing an elapsed duration of each of the plurality of ITSM records. That is, a measurement of the elapsed duration of ITSM record activity associated with an SLT database entry corresponding to an ITSM record may be incrementally advanced in an update of the SLT database to reflect time elapsed since the prior SLT database update. The increment of progression of the elapsed duration of each of the plurality ITSM records may be based on a corresponding updated SLT state of each of the plurality of ITSM records. That is, the increment of progression of the elapsed duration may be an increment corresponding to the amount of time that elapsed since the prior SLT database update only during the portions of that period when the SLT state associated with an ITSM record was active. Additionally, the increment of progression of the elapsed duration may be based on a working schedule (e.g., a dedicated working occurrences table, etc.) for the ITSM resources assigned to the ITSM record. That is, the increment of progression of the elapsed duration may be an increment corresponding to the amount of time that elapsed since the prior SLT database update only during the portions of that period when the SLT state associated with an ITSM record was active and the working schedule of an ITSM resources assigned to the ITSM record was available to perform work on the ITSM record.

The target date update module 232 may include CRI that when executed by the processing resource 222 may include updating a target date of each of the plurality of ITSM records. The target date may include the date and/or time by which a milestone should be reached. The target date may be based on a target duration specified in a SLA. Additionally, a target date may be based on an updated elapsed-duration of each of the plurality of the ITSM records. For example, a particular ITSM record may be associated with a target duration specified in an SLA specifying a maximum amount of time that is allotted to resolve the ITSM record and a target date may be determined and/or updated based on the total time remaining of the target duration minus the elapsed-duration.

Additionally, the target date update module 232 may include CRI that when executed by the processing resource 222 may calculate a working period of an ITSM resource. Calculating a working period of an ITSM resource may include calculating a period of time during which an ITSM resource such as an IT service agent is available to perform work on ITSM records. Calculating the working period may include analyzing a working schedule of an ITSM resource such as, for example, analyzing iCalendar formatted expressions defining a working schedule of an ITSM resource. For example, an IT service agent may utilize a calendar application that incorporates iCalendar computer files to define a working schedule as every weekday from 8 am to 5 pm. This general iCalendar expression may define a recurrence pattern of a working schedule. Calculating a working period may include analyzing these iCalendar expressions and identifying working schedules of ITSM records.

The target date update module 232 may include CRI that when executed by the processing resource 222 may create a dedicated working-occurrences database table storing a working-occurrence associated with each of the plurality of ITSM records. Creating the dedicated working-occurrences database may include spanning the calculated working periods into a dedicated table in which specific dates and times during which an IT resource will be available for working on ITSM records. Such a dedicated working-occurrences table creates a unified shared table for all the varied working schedules of IT resources available.

As described above, the dedicated working-occurrences table may be utilized in determining and updating a target for each of the plurality of ITSM records. The working-occurrences table may be utilized in determining a target date associated with an ITSM record milestone. For example, a target duration may be twelve hours for resolution of an ITSM record opened on a Monday morning, but the IT resource assigned to resolving the ITSM record may be scheduled to work six hours on Monday and six hours of Friday. Accordingly, the target date may be determined utilizing the target duration and the working-occurrences table. In this example, the target date may be determined to be Friday evening since that is the date and time that twelve hours with an available assigned IT resources will have elapsed. Joint operations may be performed over the SLT database and the dedicated working-occurrences table in order to determine and update a target date.

Similarly, the elapsed-duration of an ITSM record may be determined based on the working-occurrences table. For example, an elapsed-duration of a particular ITSM record may include a duration of time elapsed with an active ITSM record during which an IT resource assigned to the ITSM record is scheduled to perform work according to a corresponding working-occurrence in a working-occurrences table. Joint operations may be performed over the SLT database and the dedicated working-occurrences table in order to determine and update an elapsed-duration.

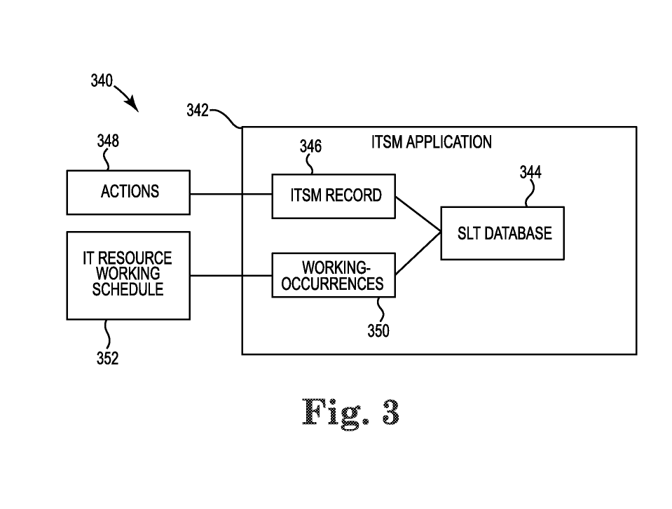

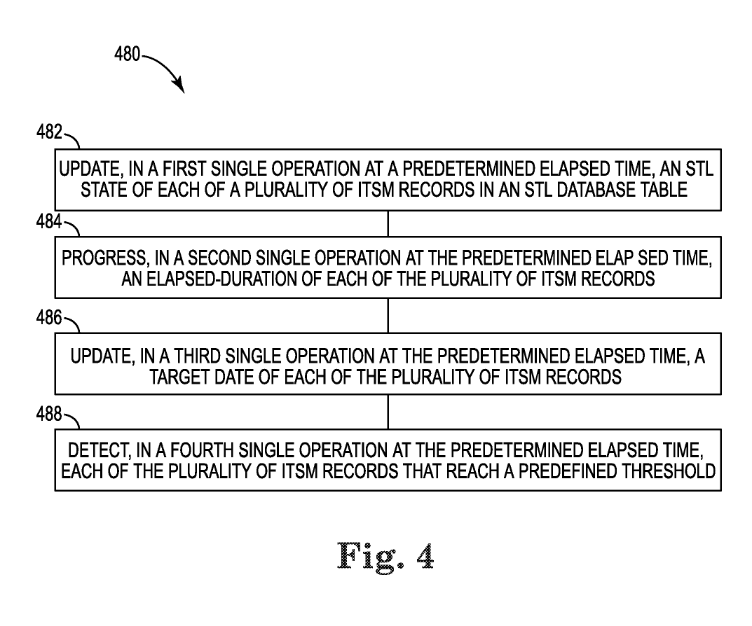

FIG. 3 illustrates an example environment 340 suitable for SLT tracking. The environment 340 is shown to include an ITSM application 342, an SLT database table 344, and ITSM record 346, actions 348, a working-occurrences database table 350, and an IT resource working schedule 352. The example environment 340 may be suitable for SLT tracking utilizing a system (e.g., system 100 as referenced in FIG. 1), a computing device (e.g., computing device 220 as referenced in FIG. 2), and a method (e.g., method 480 as referenced in FIG. 4).

The environment 340 may include an ITSM application 342. The ITSM application 342 may be an information technology service management platform that may manage services, application, and hardware across an IT environment. The ITSM application 342 may be a software as a service (SaaS) ITSM platform (e.g., delivered as a hosted cloud-based service over the Internet). The ITSM application 342 may include CRI that when executed by a processing resource may coordinate IT service requests and IT service resources to service the request across a managed IT environment.

The ITSM application 342 may coordinate IT service requests with IT resources to service the request by generating an ITSM record 346. An ITSM record 346 may include an electronic record of an IT service request and/or the work performed in resolving the underlying request. The ITSM record 346 may be used by the ITSM application 342 as a record of the application of IT resources to an IT service request. The ITSM application may manage a plurality of IT service requests and other IT incidents and each may be associated with an ITSM record 346. An ITSM record 346 may be assigned to a specific target definition. A target definition may include a target duration (e.g., how much time is allowed to elapse in supplying a resolution to the ITSM record 346) and an IT resource working schedule 352 assignment. Therefore, a specific ITSM record 346 may be assigned to a specific target duration and this assignment may define how much time is allowed to pass (and according to which IT resource working schedule 352) before a specific service must have been supplied for a submitter of the specific ITSM record 346. The assignment may be defined according to specific properties of the ITSM record 346. For example a priority associated with an ITSM record 346 may be utilized in determining a target definition assignment for the ITSM record 346. In an example, if a first ITSM record 346 has a high priority it may be assigned to a target definition defining that the first ITSM record 346 should be answered within a relatively short period of time (e.g., shorter target duration) relative to a second ITSM record having a lower priority. A change in the properties of the ITSM record 346, such as the priority may cause the target definition to be modified. For example, if the priority of an ITSM record 346 is increased then the target duration defined by the target definition may be decreased.

The ITSM application 342 may include an SLT database table 344. The SLT database table 344 may serve as a single database table of SLT information for each of a plurality of ITSM records 346 represented as individual SLT database entries. The SLT database table 344 may include a comprehensive set of values for each of the SLT database entries. For example, the SLT database table 344 may include an SLT state, a target-date, an elapsed-duration, and an SLT status associated with each SLT database entry corresponding to each of a plurality of ITSM records 346.

The ITSM application 342 may include a working-occurrences database table 350. A working-occurrences database table may exploit that working schedules 352 of a plurality of ITSM resources are a common shared resource among a plurality of ITSM records 346. That is, a working schedule 352 of each IT resource may be information that is common and/or universal within the ITSM application 342 since the pool of IT resources is a common pool from which the ITSM application 342 may draw to resolve an ITSM record 346 thereby rendering the working schedule 352 of an IT resource potentially applicable to every ITSM record 346 being managed. In this manner, two separate ITSM records 346 may utilize the same IT resource, therefore rendering the working schedule 352 of that IT resource applicable to both.

The working-occurrences database table 350 may be a single dedicated database table that houses working-occurrences (e.g., relevant working periods for an assigned IT resource) for each of a plurality of target definitions. A working-occurrence for each target definition may be determined based on a corresponding working schedule 352. The working schedule 352 may be defined using a scheduling policy and exceptions to this policy (e.g., policies extracted from iCalendar expressions). From the working schedules 352 working periods relevant to a particular target definition may be calculated for a range of time (e.g., a few days, a few months, etc.) in the future and the working periods may be spanned into the dedicated working-occurrences database table 350 as a working-occurrence for each of the plurality of target definitions. The working-occurrences database table 350 may, therefore, store periods of time when each of the plurality of IT resources are available to perform work within a target definition.

The SLT database table 344 may be updated in order to track performance of the ITSM application 342 against SLTs. That is, an IT service agent can track their respective SLTs realization such as responding to and resolving ITSM records 346 as defined in an SLA utilizing the information managed by the ITSM application 342 such as the SLT information stored within the SLT database table 344. The SLT information within the SLT database table 344 may be periodically updated. In contrast to computationally intensive event-based updating, the ITSM application 342 may update the SLT database table 344 within a predetermined frequency. That is, the SLT database table 344 may be updated upon a predetermined elapsed period of time (e.g., one minute). Upon the passage of the predetermined elapsed period of time a calculation cycle may be initiated, which updates the SLT database table 344.

The calculation cycle may include aggregating of each of a plurality of actions 348 performed over an ITSM record since the last calculation cycle. An action 348 may be a work event performed on the IT service item associated with the ITSM record. The action 348 may refer to the physical action taken on the IT service item and/or the record of a physical action taken on the IT service item associated with the corresponding ITSM record 346. The action 348 may be a work event that denotes an interaction of an IT resource and/or an end user with the IT service item. The action 348 may be an event that results in a modification of an IT service item and/or the corresponding ITSM record 346.

In utilizing the predetermined elapsed duration cycle of updating a SLT database table 344 it may be the case that multiple actions 348 have been taken over multiple ITSM records 346 in the intervening time between calculation cycles. The ITSM application 342 may aggregate these actions 348. Aggregating the actions 348 may include identifying an SLT action type associated with each action 348. Aggregating the actions 348 may include grouping actions of the same type for performance of those actions 348 in a single bulk operation over the SLT database table 344. Performance of the actions 348 may include applying a change to an SLT database table entry resulting from an action 348 performed on a corresponding ITSM record 346 and/or the underlying IT service item. For example, if one of the actions performed in the intervening period between calculation cycles was suspending work on an ITSM record 346, then a relevant SLT state row in the SLT database table 344 may be modified from active to inactive and a relevant SLT status row in the SLT database table 344 may be modified from active to suspended.

A compression mechanism may be utilized in order to compress different actions 348 performed over the same ITSM record 346 in the same intervening time between calculation cycles. For example, an ITSM record 346 may have actions 348 performed on it that lead to the ITSM record 346 being created, suspended, unsuspended, stopped, and/or restarted in the same intervening time between calculation cycles. Rather than translating each action 346 individually via individual SQL operations upon relevant rows of the SLT database table 344, multiple actions 346 and their corresponding SLT state transitions may be processed by a state machine and compressed into a single SQL operation to maintain an accurate SLT state.

The calculation cycle may include comprehensively progressing an elapsed-duration of each of the ITSM records 346 and/or their corresponding SLT database table entries in a single bulk operation using a dedicated database query. Progressing an elapsed-duration may include tracking and/or determining a previous cycle time. A previous cycle time may be a time point when a previous calculation cycle and/or SLT database table 344 update. Progressing an elapsed-duration may include tracking and/or determining a current time. A current time may be a time point corresponding the time at which the calculation cycle is being executed.

Given the previous cycle time and the current time, the elapsed-duration may be progressed in the SLT database table 344 by an amount of time that has passed since the prior calculation cycle. However, the elapsed-duration may be progressed by only a portion of the time that has passed since the prior calculation cycle. That portion may be the portion corresponding to a working-occurrence in the working-occurrences database table 350 specifying when an assigned IT resource is scheduled to be performing work. For example, if time elapsed since the last calculation cycle is equal to one minute, but the working-occurrence of an assigned IT resource during that same time period was thirty seconds, then the elapsed-duration may be progressed by only thirty seconds.

Further, the portion of the time that has passed since the prior calculation cycle may include only those portions of time during which the ITSM record 346 was active (e.g., had an active SLT state, did not have a suspended, achieved, or failed SLT status). That is, the elapsed-duration may be progressed by the amount of time that it was active. Further, the elapsed-duration may be progressed by the amount of time that the ITSM record 346 was active and during which an assigned IT resource is scheduled to be performing work.

Since multiple actions 348 may be taken over multiple ITSM records in the intervening time between calculation cycles, an ITSM record 346 may oscillate between an active and inactive SLT states during this time. Since it may be desirable to progress the elapsed-duration of only active ITSM records 346, timestamps may be determined and/or associated with each action 348 in order to identify those portions of the intervening time between calculation cycles that correspond to when the ITSM record 346 had an active SLT state. For example, if an ITSM record 346 was created, started, and/or unsuspended in the middle (duration X) of the intervening time (duration Y) between calculation cycles then the corresponding elapsed-duration may be progressed by Y-X.

The actions 348 and the associated timestamps may be stored in SLT database table 344 prior to elapsed-duration update. In this manner, dedicated corresponding columns in this database table may be utilized to take into account actions 348 and their pre-calculated timestamps in updating an elapsed duration. To update the elapsed-duration a join may be performed between the SLT database table 344 and the occurrences table and rows corresponding to each SLT database entry may be located utilizing SQL range operators.

The calculation cycle may also include calculating an updated SLT status of each of the ITSM records 346. The updated SLT status may be calculated by comparing an updated elapsed-duration and the target duration associated with each ITSM record 346 to determine whether the elapsed-duration has exceeded the time allotted in the target duration. This comparison may occur by directly comparing the columns of the SLT database entries corresponding to the target duration and the updated elapsed-duration of each ITSM record 346. Calculating the updated SLT status may include updating the SLT status of each of the ITSM records 346. Updating the SLT status of each of the ITSM records 346 may include modifying the SLT status associated with a corresponding SLT database table entry saved in the SLT database table 344. For example, a SLT database table entry may be updated to reflect a change in the SLT status of a corresponding ITSM record 346 between active, breached, achieved, and/or failed SLT status.

The calculation cycle may include calculating an updated target date of an ITSM record 346. An update target date may be calculated in a dedicated database query as a calculation in a single SQL operation over all the ITSM records 346. The target date may change following various actions 348 performed on the ITSM record 346. For example, an action 348 that starts or unsuspends an ITSM record 346 may lead to progression of the elapsed-duration and depletion of the time remaining in the target duration. In another example, an action 348 that suspends an ITSM record 346 may pause the elapsed-duration and/or the depletion of the time remaining in the target duration, but may progress the end target date by the amount of time during which the ITSM record 346 is suspended. Additionally, the target date may be modified following a change in the target duration and or working schedule 352 of the target definition assigned to the ITSM record 346. The updated target date may be calculated based on action timestamps of actions 348 performed on the ITSM record 346, the elapsed-duration of the ITSM record 346 so far, the target duration and an assigned IT resource working schedule 352. For example, the target date may be the date corresponding to the total remaining target duration (target duration−elapsed-duration) as elapsed over an assigned resource working schedule 352.

An example calculation of an updated target date for a single ITSM record 346 may include calculating in a memory resource (not shown) the working occurrences throughout a life cycle of the ITSM record 346. In contrast to the computationally intensive method of determining updated target dates over each of the ITSM records 346 separately, the ITSM application 342 may exploit the fact that a plurality of IT resource working schedules 352 are shared among a plurality of distinct ITSM records 346 and utilize the working-occurrences database table 350 in determining the updated target date for all the ITSM records 346 in a single SQL operation. For example, a dedicated query may perform a join between the SLT database table 344 and the working-occurrences database table 350 while locating relevant actions timestamps in the SLT database table 344. The joined rows of working-occurrences database table 350 may then be aggregated from that point until the elapsed-duration reached the required duration. This method may supply the updated target date for all the ITSM records 346 in the SLT database table 344 in a single SQL operation.

The calculation cycle may include detecting ITSM records 346 that reach a predefined threshold and/or set of thresholds in another dedicated database query. Detecting threshold reaching may be utilized to actively track SLT progress. Further, detecting threshold reaching may be incorporated into monitoring, modifying, and generating communications regarding an ITSM record 346 lifecycle. For example, an end user associated with an ITSM record 346 may request that he will receive a notification when fifty percent of the target duration for the ITSM record 346 has been consumed. An end user associated with an ITSM record 346 may also request to edit attributes of the ITSM record 346 following reaching a specific threshold. In contrast to the computationally intensive single-record-based method of managing threshold reaching, a single bulk operation may be utilized to detect threshold reaching of a plurality of ITSM records 346 and manage any events triggered there from.

Detecting ITSM records 346 that reach a predefined threshold may include tracking a consumed percentage of various ITSM records 346 over their corresponding target durations and utilizing timers to detect when a single ITSM record 346 reaches a threshold. Detecting ITSM records 346 in this manner may be triggered simply by time going by rather than by actions performed over the ITSM records 346. The ITSM application 342 may exploit the above-described background process that updates the elapsed-duration of all ITSM records 346 in a predetermined temporal frequency to detect threshold reaching. That is, given the updated elapsed-duration and the target duration of an ITSM record 346, the consumed percentage of the target duration may be extracted in a dedicated column of the SLT database table 344. In a dedicated column of the SLT database table 344 a prior consumed percentage of the target duration may be stored at the beginning of a cycle and then a join may be performed between a predefined table of thresholds (not shown) to find the rows of the SLT database table 344 in which the previous percentage is smaller than a given threshold value and the new percentage is larger than this threshold. The results may be outputted to the end user utilizing an event-triggered mechanism.

The calculation cycle may further include updating target definitions of multiple ITSM records 346 that have been modified in the intervening time between calculation cycles. Occasionally, a contract (e.g., SLA) under which the ITSM application 342 coordinates the supply of IT services to end users may be modified. A resulting change to a target definition may be captured and may cause a corresponding modification to an SLT status and/or a target date of an associated active ITSM record 346. The SLT database table 344 may be updated following modifications to the target definitions. The modifications of the target definitions resulting from contract changes may be aggregated. For example, a background process may be performed in a predetermined temporal frequency which compares previous and current target definitions and marks in the SLT database table 344 the definitions that have been updated since the last calculation cycle. Applying the changes over the SLT database table 344 may then be performed wising a dedicated database query, which recalculated the SLT status and target date for each of the ITSM records 346.

FIG. 4 illustrates a flow chart of an example of a method 480 of SLT tracking. In some examples, the method 480 may be performed utilizing a system (e.g., system 100 as referenced in FIG. 1) and/or a computing device (e.g., computing device 220 as referenced in FIG. 2).

As illustrated at 482, the method 480 may include updating, in a first single operation at a predetermined elapsed time, a SLT state of each of a plurality of ITSM records in a single SLT database table. Updating an SLT state may be performed based on an aggregation of a plurality of actions performed on each of the ITSM records since a previous update.

As illustrated at 484, the method 480 may include progressing, in a second single operation at the predetermined elapsed time, an elapsed-duration of each of the plurality of ITSM records. The elapsed-duration of an ITSM record may be progressed by a portion of the time elapsed since a prior update corresponding to time when the ITSM record was active and when an assigned IT resource was scheduled to be working.

As illustrated at 486, the method 480 may include updating, in a third single operation at the predetermined elapsed time, a target date of each of the plurality of ITSM records. The target date of an ITSM record may be updated based on a target duration defined by an assigned target definition, an elapsed-duration, and future working occurrences of an assigned IT resource.

As illustrated at 488, the method 480 may include detecting, in a fourth single operation at the predetermined elapse time, each of the plurality of ITSM record that reach a predefined threshold. For example, a consumed percentage of a target duration defined in a target duration may be compared to a threshold consumed percentage to detect when a threshold has been reached. An event such as an email notification to an end user regarding the ITSM record may be triggered upon detecting a threshold is reached. Further, the method 480 may include updating in a fifth single operation at the predetermined elapsed time, a target definition associated with each of the plurality of ITSM records (not shown). For example, if an SLA is updated influencing target definitions, the target definitions may be updated to reflect any modification of the definitions. Updating the target definitions may include recalculating a target date and an SLT states for each of the plurality of ITSM records with a modified target definition.

As used herein, “logic” is an alternative or additional processing resource to perform a particular action and/or operation, etc., described herein, which includes hardware, e.g., various forms of transistor logic, application specific integrated circuits (ASICs), etc., as opposed to computer executable instructions, e.g., software or firmware, etc., stored in memory and executable by a processor. Further, as used herein, “a” or “a number of” something may refer to one or more such things. For example, “a number of widgets” may refer to one or more widgets.

The figures herein follow a numbering convention in which the first digit or digits correspond to the drawing figure number and the remaining digits identify an element or component in the drawing. As will be appreciated, elements shown in the various examples herein may be added, exchanged, and/or eliminated so as to provide a number of additional examples of the present disclosure. In addition, as will be appreciated, the proportion and the relative scale of the elements provided in the figures are intended to illustrate certain examples of the present disclosure, and should not be taken in a limiting sense.

The above specification, examples and data provide a description of the method and applications, and use of the system and method of the present disclosure. Since many examples may be made without departing from the spirit and scope of the system and method of the present disclosure, this specification merely sets forth some of the many possible example configurations and implementations.

What is claimed is:

1. A system for service level target (SLT) tracking comprising:
an aggregate engine to aggregate a plurality of actions performed on each of a plurality of information technology service management (ITSM) records in a single SLT database table since a prior update;
an apply engine to apply the aggregated plurality of actions to the SLT database table in a bulk operation; and
an update engine to update, at a predetermined elapsed time, each of the plurality of ITSM records in the SLT database table.

2. The system of claim 1, further comprising the apply engine to perform each action, of the aggregated plurality of actions, of a specific type in a single operation.

3. The system of claim 1, further comprising the apply engine to modify an SLT state associated with an ITSM record based on a corresponding applied action.

4. The system of claim 1, further comprising the update engine to update an elapsed-duration of each of the plurality of records in a single operation.

5. The system of claim 1, further comprising the update engine to progress an elapsed-duration of a portion of the plurality of ITSM records that have an active SLT state.

6. The system of claim 1, further comprising the update engine to determine an updated SLT status of each of the plurality of ITSM records.

7. The system of claim 6, wherein determining the updated SLT status of each of the plurality of ITSM records is based on comparing a corresponding updated elapsed duration and a target duration for each of the plurality of ITSM records.

8. The system of claim 1, further comprising the update engine to update a target date of each of the plurality of ITSM records in a single operation.

9. A non-transitory computer readable medium storing instructions executable by a processing resource to cause a computer to:
update each of a plurality of information technology service management (ITSM) records in a single service level target (SLT) database table in a single bulk operation at a predetermined elapsed time, wherein to update comprises:
updating the SLT state of each of the plurality of ITSM records based on an aggregation of a plurality of actions performed on each of the ITSM records since a prior update;
progressing an elapsed-duration of each of the plurality of ITSM records based on a corresponding updated SLT state of each of the plurality of ITSM records; and
updating a target date of each of the plurality of ITSM records based on the corresponding updated elapsed-duration of each of the plurality of the ITSM records.

10. The non-transitory computer readable medium of claim 9, further comprising instructions executable by a processing resource to calculate a working period of an ITSM resource and creating a dedicated working-occurrences database table storing a working-occurrence associated with each of the plurality of ITSM records.

11. The non-transitory computer readable medium of claim 10, wherein updating the target date of each of the plurality of ITSM records is based on a corresponding working-occurrence associated with each of the plurality of the ITSM records.

12. A method of service level target (SLT) tracking comprising:
updating, in a first single operation at a predetermined elapsed time, a SLT state of each of a plurality of information technology service management (ITSM) records in a single SLT database table based on an aggregation of a plurality of actions performed over each of the ITSM records since a prior update;
progressing, in a second single operation at the predetermined elapsed time, an elapsed-duration of each of the plurality of ITSM records;
updating, in a third single operation at the predetermined elapsed time, a target date of each of the plurality of ITSM records; and
detecting, in a fourth single operation at the predetermined elapsed time, each of the plurality of ITSM records that reach a predefined threshold.

13. The method of claim 12, further comprising updating, in a fifth single operation at the predetermined elapsed time, a target-definition associated with each of the plurality of ITSM records.

14. The method of claim 12, wherein updating the target-definition includes recalculating a target-date and SLT status for each of the plurality of ITSM records with a modified target-definition.

15. The method of claim 12, wherein detecting each of the plurality of ITSM records that reach the predefined threshold includes determining a consumed-percentage of a target duration relative to the predefined threshold for each of the plurality of ITSM records.
